(19) United States
(12) Patent Application Publication
(10) Pub. No.: US 2026/0017762 A1
(43) Pub. Date: Jan. 15, 2026

(54) ADAPTIVE SAMPLING METHODS FOR DIFFUSION MODELS FOR SYNTHETIC DEFECT IMAGE GENERATION

(71) Applicant: Samsung Display Co., Ltd., Yongin-si (KR)

(72) Inventors: Rahul Shenoy, San Jose, CA (US); Zhihong Pan, San Jose, CA (US); Kaushik Balakrishnan, Fremont, CA (US); Janghwan Lee, Pleasanton, CA (US)

(21) Appl. No.: 18/913,552

(22) Filed: Oct. 11, 2024

Related U.S. Application Data
(60) Provisional application No. 63/671,667, filed on Jul. 15, 2024.

(51) Int. Cl. G06T 5/70; G06T 11/00; G06V 10/764; G06V 10/774

(52) U.S. Cl. CPC G06T 5/70; G06T 11/00; G06V 10/764; G06V 10/774

(57) ABSTRACT

A method may include applying noise to a first real image to generate a first noisy image. Then, the method may include generating a first synthetic image corresponding to an estimate of a first class of synthetic image, and computing a guidance strength of the first synthetic image based on probabilities determined from a multi-class classifier, wherein the probabilities may include a first probability of the first class of synthetic image and a second probability of a second class of synthetic image, and denoising an amount of noise determined based on the guidance strength.

### CROSS-REFERENCE TO RELATED APPLICATION

This application claims the priority benefit under 35 U.S.C. § 119(e) of U.S. Provisional Application No. 63/671,667, filed on Jul. 15, 2024, the disclosure of which is incorporated by reference in its entirety as if fully set forth herein.

### FIELD

The present disclosure generally relates to defect classification using artificial intelligence. More particularly, the subject matter disclosed herein relates to adaptive sampling methods for diffusion models for synthetic defect image generation.

### SUMMARY

Production of electronic devices, for example, television and mobile display devices have grown rapidly over the recent years. To keep up with the mass production of such devices, there have been efforts to improve manufacturing techniques and efficiencies, for example, by detecting, classifying, and repairing defects in the circuitry when they are produced at the manufacturing line. Improved techniques leveraging artificial intelligence (AI) and machine learning (ML) in such processes in alignment with emerging Industry 4.0/Smart Manufacturing paradigm are desired.

According to an embodiment of the present disclosure, a method may include applying, by a processor, noise to a first real image to generate a first noisy image; generating, by the processor, a first synthetic image corresponding to an estimate of a first class of synthetic image; computing, by the processor, a guidance strength of the first synthetic image based on probabilities determined from a multi-class classifier, the probabilities including a first probability of the first class of synthetic image and a second probability of a second class of synthetic image; and denoising, by the processor, an amount of noise determined based on the guidance strength.

The first real image may be a defect free image of a target.

The first class of synthetic image may correspond to a desired class of a defect image of a target.

The guidance strength may be computed using an exponential function of a difference between the first probability of the first class of synthetic image and the second probability of the second class of synthetic image.

The second class of synthetic image may correspond to a reference class of image of a target, the reference class being another class of a defect image of the target.

The guidance strength may be relatively lower in response to the first probability of the first class of synthetic image being a highest probability out of all classes of the multi-class classifier.

The guidance strength may be relatively higher in response to the second probability of the second class of synthetic image being a highest probability out of all classes of the multi-class classifier.

The guidance strength may be computed using a power law function.

The multi-class classifier may be trained based on a source.

The method may further include generating the first class of the synthetic image responsive to the denoising.

According to an embodiment of the present disclosure, a system may include: a processor; and a memory storing instructions executed by the processor to cause the processor to: apply noise to a first real image to generate a first noisy image; generate a first synthetic image corresponding to an estimate of a first class of synthetic image; compute a guidance strength of the first synthetic image based on probabilities determined from a multi-class classifier, the probabilities including a first probability of the first class of synthetic image and a second probability of a second class of synthetic image; and denoising, by the processor, an amount of noise determined based on the guidance strength.

The first real image may be a defect free image of a target.

The first class of synthetic image may correspond to a desired class of a defect image of a target.

The guidance strength may be computed using an exponential function of a difference between the first probability of the first class of synthetic image and the second probability of the second class of synthetic image.

The second class of synthetic image may correspond to a reference class of image of a target, the reference class being another class of a defect image of the target.

The guidance strength may be relatively lower in response to the first probability of the first class of synthetic image being a highest probability out of all classes of the multi-class classifier.

The guidance strength may be relatively higher in response to the second probability of the second class of synthetic image being a highest probability out of all classes of the multi-class classifier.

The guidance strength may be computed using a power law function.

The multi-class classifier may be trained based on a source.

The system may cause the processor to further generate the first class of the synthetic image responsive to the denoising.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a factory that produces, for example, electronic devices, such as organic light-emitting diode (OLED) devices, according to one or more embodiments of the present disclosure.

FIG. 2A is an example defect-free image of a source, FIG. 2B is an example defect image of the source, FIG. 2C is an example defect-free image of target, and FIG. 2D is an example defect image of the target, according to one or more embodiments of the present disclosure.

FIG. 3 is a flow chart of an overall method for generating fake defect images to train a classifier that can ultimately be deployed in the factory and used to perform inspections, according to one or more embodiments of the present disclosure.

FIG. 4 is a diagram illustrating a process for training a multi-class diffusion model on a source product, according to one or more embodiments of the present disclosure.

FIG. 5 is a diagram illustrating a process for sampling (or generating) synthetic defect (NG) images from a diffusion model, according to one or more embodiments of the present disclosure, according to one or more embodiments of the present disclosure.

FIG. 6 illustrates the steps for enriching synthetic defect image generation based on the adaptive guided sampling method, according to one or more embodiments of the present disclosure, according to one or more embodiments of the present disclosure.

FIG. 7 is a flow chart of a method for synthetic defect image generation using diffusion models, according to one or more embodiments of the present disclosure.

FIG. 8 is a block diagram of an electronic device in a network environment, according to according to one or more embodiments of the present disclosure.

Embodiments of the present disclosure and their advantages are best understood by referring to the detailed description that follows. Unless otherwise noted, like reference numerals denote like elements throughout the attached drawings and the written description, and thus, descriptions thereof will not be repeated. In the drawings, the relative sizes of elements, layers, and regions may be exaggerated for clarity.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

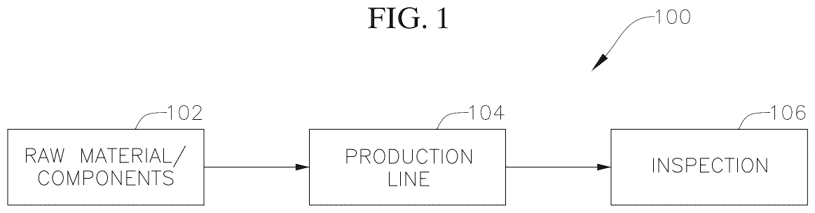

Manufacturing of products in a factory or a production line may include various processes to ensure certain quality requirements are satisfied. FIG. 1 is block diagram of a factory that produces, for example, electronic devices, such as organic light-emitting diode (OLED) devices. The production line 104 may be a system of machines, machinery, or devices, that take raw materials and/or components 102 as inputs and assembles, constructs, or produces one or more products such as the OLED devices. At the output of the production line 104, an inspection 106 system or mechanism may be implemented to conduct quality assurance by looking for defects in the product or portions of the products (e.g., in the circuitry) to classify the defects, and in some instances even repair the defects.

It is desirable to identify defects in the Mobile Display OLED manufacturing process with high accuracy for efficiency and robustness. In some systems, much of the defect identification, classification, and repair process may be undertaken by human personnel in a Remote Operator System (ROS) who remotely operate the auto repair process. However, this approach may be relatively costly as it involves a large number of human operators in the defect identification and defect repair stages. This process may also be relatively time consuming and prone to human error, which makes the overall system inefficient. To make the manufacturing process more robust, an artificial intelligence (AI)-based defect classification and repair system may be utilized according to some embodiments. However, to build an AI-based classifier, it may be desirable to have data balance between the number of defect-free (OK) and defect (NG) sample images used to train the AI model. This, however, may be difficult because the number of defect samples in manufacturing are typically a very small subset of the total (e.g., 1-2% of the total), and therefore may hinder the development of a robust defect detection classifier.

An AI-based generative model may be utilized to overcome this problem. The AI generative model may learn the data distribution of defect-free (OK) and defect (NG-1/NG-2/NG-3/ . . . ) samples from source products and transfer them to OK images from target products to create synthetic NG-k (k=1, 2, 3, . . . ) images for the target products. The number of defect types can be large, for example, 20+ different types of defects, and therefore each type of defect may be distinguished as NG-1, NG-2, NG-3, and so on. The defects may appear in different shapes, sizes, and locations (e.g., location with respect to the background circuitry that is being inspected). Herein the present disclosure, the term “source” or “source products” may refer to those products that have been in mass production for a reasonably long time (e.g., more than one year) such that a large corpus of manufacturing defect images is available. On the other hand, the term “target” or “target products” may refer to those products that are relatively newer, for example, those that were introduced in the factory relatively recently and therefore many defect images are not available. Thus, the lack of many defect images may hinder the development of classifiers for the auto repair system. Therefore, it is desired for an AI-based generative model to learn the defect distribution from the source products, and then transfer the defects from source products to target products, thereby creating fake (or synthetic) defect images for the target products. Furthermore, variations in the defect may be learned by the generative model so that good quality fake NG-k (k=1, 2, 3, . . . ) images can be generated by the AI model. Moreover, it is desirable for a robust AI model to generate synthetic defect images where the location of the defect is consistent with the circuit patterns in the background. Therefore, techniques to train AI models and sample fake images from them at a high image resolution is needed.

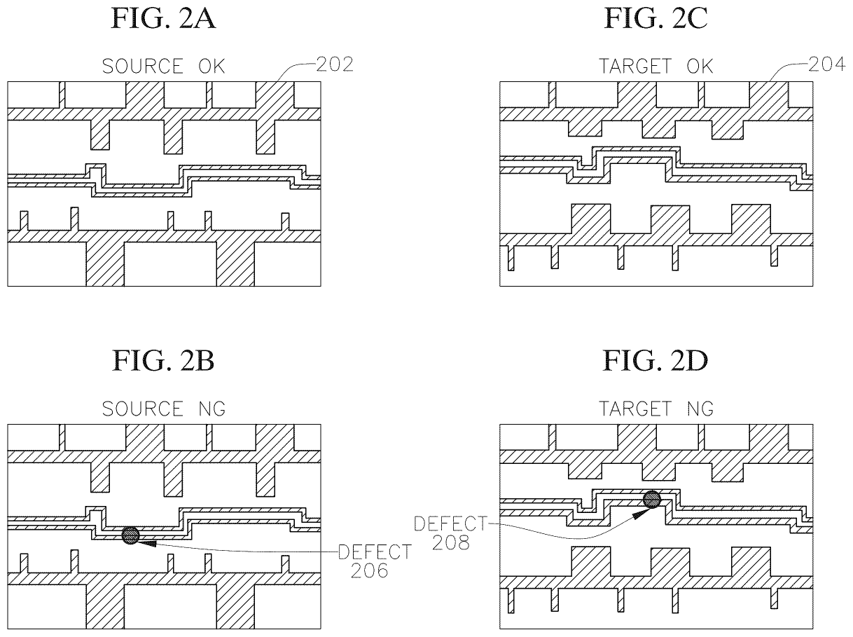

FIG. 2A is an example defect-free image of a source, FIG. 2B is an example defect image of the source because there is a defect 206 present in the image, FIG. 2C is an example defect-free image of target, and FIG. 2D is an example defect image of the target because there is a defect 208 present in the image. Herein the present disclosure, a defect may refer to some type of abnormality in the product or device that is captured in an image by the inspection system. The defect may result from the production line, for example, malfunctioning during the manufacturing process. Therefore, in the case of an electronic device or circuitry, the defect may include, for example, a short circuit or open circuit in the wiring or traces on a circuit board. Accordingly, FIG. 2A shows a close-up view of a portion of an example circuit board illustrating traces 202 of a source product or device that is defect free. Similarly, FIG. 2C shows a close-up view of a portion of an example circuit board illustrating traces 204 of a target product or device that is defect free. Thus, although the target circuit board is not an identical circuit board as the source, there are some similarities between the source and the target.

Therefore, according to some embodiments, a generative-AI system may be used to take a defect image from the source and generate a synthetic defect image on the target. This process may be used to generate a sufficient amount of defect images so that an AI-classifier for the target product may be trained so that it can classify images and automatically repair any defects. Accordingly, a neural network of the diffusion model may be trained from the source device such that the trained neural network can be used to take OK images of the target device and generate synthetic defect (NG) images of the target device. In other words, the defect image of the source product such as that shown in FIG. 2B may be used to train the neural network such that this neural network may be used on the target product to generate a synthetic defect image of the target product such as that shown in FIG. 2D. Therefore, even though the image of the target product did not have a defect (as shown in FIG. 2C), a “fake” defect 208 may be generated on the image of the target product as shown in FIG. 2D.

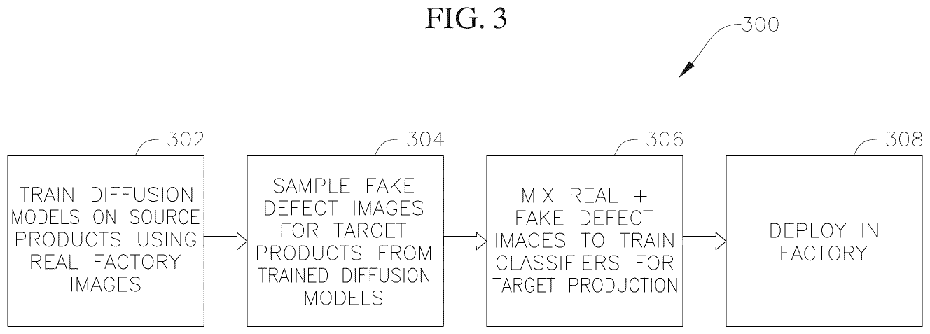

FIG. 3 is a flow chart of an overall method for generating fake defect images to train a classifier that can ultimately be deployed in the factory and used to perform inspections. Although FIG. 3 illustrates various operations in a method for generating fake defect images to train a classifier, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

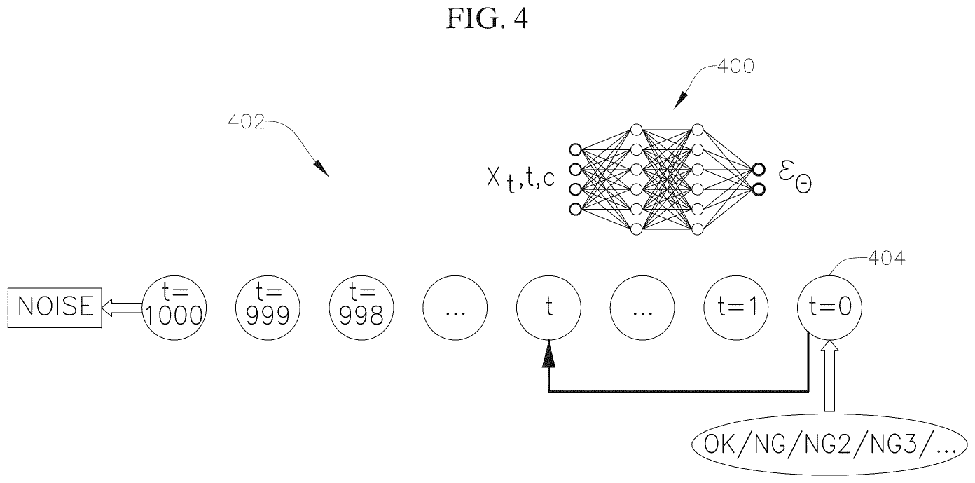

A diffusion model is an example of a generative model that may be used to generate synthetic images. Therefore, the diffusion model may be trained using real images from a source product in a factory (operation 302). For example, high resolution images may be captured by an inspection system following the production of various components or elements of a device, and such images may be used to train a diffusion model. In more detail, FIG. 4 is a diagram of an example neural network 400 of a multi-class diffusion model and a diagram illustrating a process 402 for training a multi-class diffusion model from a source product. Although FIG. 4 illustrates various operations in a method for training a multi-class diffusion model, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure. The diffusion training process may be illustrated as a sequence of a set number of time steps 404 (e.g., T number of time steps, where T=1000) ranging from an image that has no noise at time step t=0 to an image at time step t=1000 that is pure noise. The images between step t=0 and step t=1000 have a gradually increasing amount of noise (e.g., Gaussian noise) such that the image at step t=1 has a little bit of noise added to the image at step t=0, the image at step t=2 has a little bit more noise in addition to the image at step t=1, and so on until the step at t=1000, which is pure noise. Accordingly, the neural network 400 may be trained such that the amount of noise that is added at each step t is known. Thus, the neural network 400 may predict the amount of noise that is present in the image at any step t, and therefore, the noise may be removed to reveal or generate a purely noiseless image. In some embodiments, the diffusion model may be based on a standard Latent Diffusion Model (LDM) using a U-Net convolutional neural network (CNN) backbone architecture. The training may follow a standard procedure of Stable Diffusion such as those known by persons having ordinary skill in the art. For example, an autoencoder may be utilized to project data from pixel to latent space, where the diffusion model may be trained. In some embodiments, the learned perceptual image patch similarity (LPIPS) loss may be used to train the diffusion model.

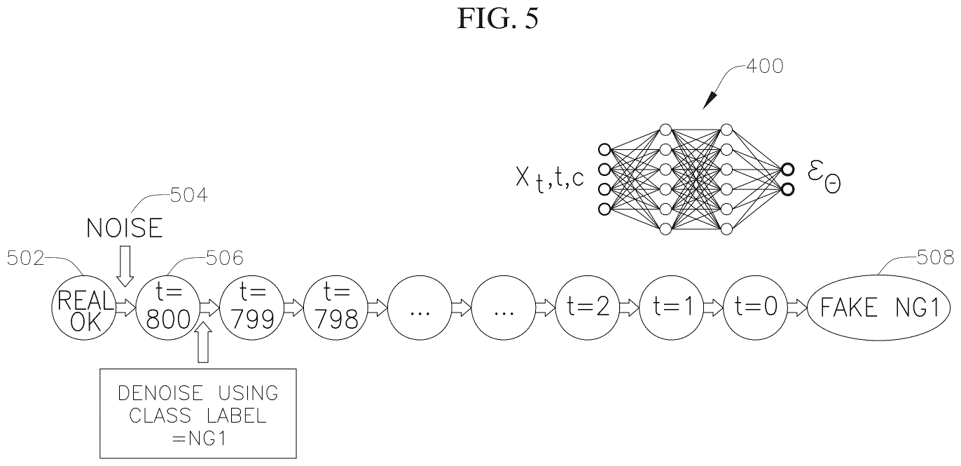

Turning back to FIG. 3, the trained diffusion model from FIG. 4 may then be used to generate fake defect images of a target product from defect free images of the target product (operation 304). For example, the target product may not have sufficient number of defect images that can be used to train a classifier, and therefore may rely on a diffusion model that was trained on a source product to generate fake defect image using generative AI. Such defects may correspond to, in the case of electronic devices, short circuits or open circuits in the wiring or traces of a circuit board. FIG. 5 is a diagram illustrating a process for generating (or sampling) fake defect (NG) images from the diffusion model, according to one or more embodiments of the present disclosure. Although FIG. 5 illustrates various operations in a method for generating fake defect images from a multi-class diffusion model, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure. In one or more embodiments, the diffusion model may be used to take an OK image from a target device and generate a synthetic NG image from the OK image based on the neural network 400 (diffusion model) that was built and trained from the source device.

In one or more embodiments of the present disclosure, the trained neural network 400 includes an input with variables Xt, t, and c, wherein Xt corresponds to a partially noisy image at time step t, t corresponds to the time step, and c corresponds to a class label that may indicate to the neural network whether to generate an OK image or one or more classes of NG images. Thus, by setting the class label c to OK, an OK image may be generated by the neural network 400. Similarly, by setting the class label to NG-1, an NG-1 image corresponding to a first type of defect image may be generated by the neural network 400, and by setting the class label to NG-2, an NG-2 image corresponding to a different type of defect image may be generated by the neural network 400.

In some embodiments, the above-described trained neural network 400 may be utilized on other devices (e.g., a target device) that do not have necessarily have enough data to train its own neural network to generate defect images. Therefore, by setting the class label c to NG1 or NG2 or NG3, a desired defect image for the target device may be generated by the neural network trained from the source device.

According to one or more embodiments of the present disclosure, the sampling process may start by taking an OK image 502 of the target device, and noise 504 (e.g., Gaussian noise) corresponding to some intermediate time step (e.g., time step t=800) may be added to the OK image 502 to generate a noisy OK image 506. Once noise has been added to the image, the class label c may be set to the desired defect class, for example NG-1, and the noise may be removed by using the diffusion model in order generate the fake NG-1 image 508. It should be noted that while there are 1000 steps t as shown in FIG. 3 with reference to training, the sampling process shown in FIG. 4 starts at step t=800 because the images at approximately steps t=800-1000 are mostly noise with the background substantially destroyed. Therefore, the sampling process may skip those portions and start denoising from an arbitrarily determined intermediate step at around step t=800, thus bypassing the images with substantial noise and instead utilize the images that have some noise and some background information. Next, some of the noise from the noisy image at step t=800 may be denoised (e.g., removed), which results in the noisy image at step t=799. This process may be continued by again denoising some of the noise from the noisy image at step t=798, which results in the noisy image at step t=798. Thus, after each denoising step, a clearer image may be generated. Through these denoising steps, an image corresponding to the defect image selected by the class label (e.g., NG-1) may be generated, which is the synthetic or fake defect image 508. Therefore, if the class label was set to NG-1, then the denoised imaged at step t=0 is a synthetic defect image of class NG-1. It should be noted that the intermediate step was set at step t=800 here by way of example, but other intermediate steps may instead be used as the starting point for the sampling process.

Turning back to FIG. 3, once a desired amount of fake defect images are generated, then the plurality of real defect images and fake defect images may be mixed to train a classifier (operation 306) of the target. In other words, the plurality of real and fake defect images, along with the defect free images become the training data, in which a classifier for a target product may use to train itself. Once the classifier is trained, the classifier may be deployed in an inspection system in a factory (operation 308). Once deployed, the inspection system may utilize the multi-class classifier to perform inspections on products that come out of the production line in the factory.

However, the defects in the images are very small and therefore the difference in the images between one type of defect image such as NG-1, and other types of defect images such as NG-2/NG-3/ . . . is very small. Thus, even though a particular class label (e.g., NG-1) may be selected, the generated fake defect may look like a defect of another class (e.g., NG-2). Therefore, one or more embodiments of the present disclosure are directed to techniques for distinguishing the difference between one type of defect image from one or more of the other defect images by enriching the generation of synthetic defect images.

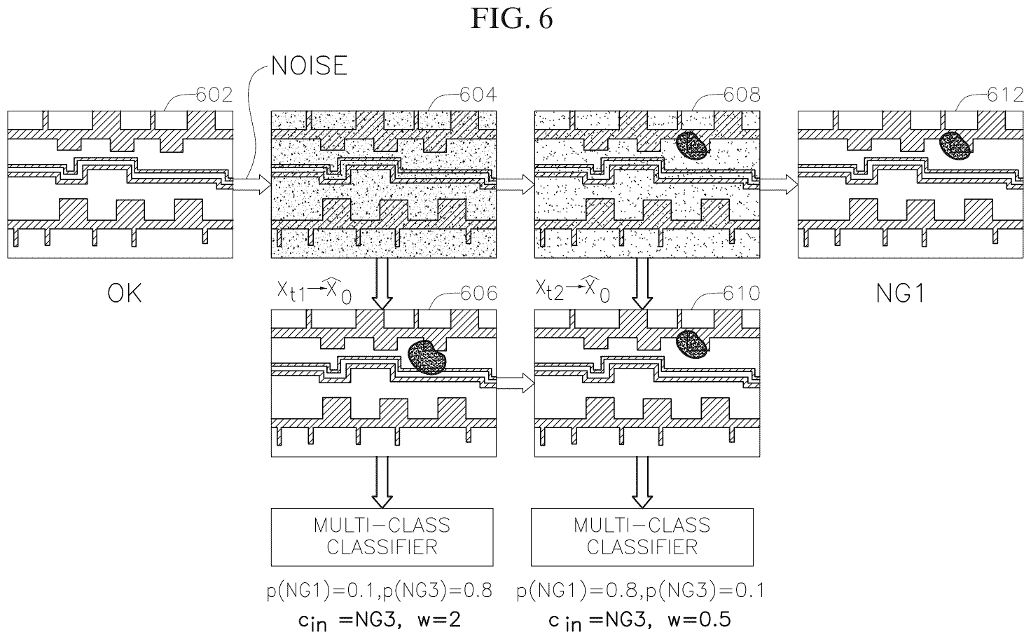

FIG. 6 illustrates the steps for enriching synthetic defect image generation according to an adaptive guided sampling method, according to one or more embodiments of the present disclosure. First, it may be assumed that a multi-class classifier of a source product already exists according to the techniques described above and/or other techniques known in the art, and that a multi-class diffusion model is already trained as described earlier with reference to FIG. 4. Then, the trained multi-class diffusion model may be utilized by additionally implementing an adaptive guided sampling technique to generate enriched fake defect images for a target product according to one or more embodiments of the present disclosure.

According to one or more embodiments, a guided adaptive sampling strategy may be utilized to sample fake defect images from trained diffusion models. For example, when it is desired to generate a defect type of class x (e.g., NG-1), guided sampling may be utilized such that during each time step t of the sampling step, class x is compared with other “similar” classes to try to maximize the difference between them so that the diffusion model is able to enhance the quality of the generated images for class x. The pre-trained multi-class classifier from a source product (i.e., another similar product) may be utilized to determine class probabilities for each defect type, and based on these probabilities, a guidance strength may be computed, which can then be utilized to compute the amount of noise to denoise. Herein the present disclosure, the terms “guidance strength” may be defined as the degree of confidence of a generated defect class relative to its desired or intended defect class. Thus, a high guidance strength value may indicate that there is less confidence in the degree of similarity of the generated defect class to the desired defect class, and therefore more guidance is needed to bring the generated defect class closer to the desired defect class. On the other hand, a lower guidance strength value may indicate that there is greater confidence in the degree of similarity of the generated defect class to the desired defect class, and therefore less guidance is needed because the generated defect class is already similar to the desired defect class.

This adaptive guided sampling technique is further illustrated in FIG. 6. Noise may be added to a defect-free (OK) image 602 of a target product, thus resulting in a noisy image 604 that corresponds to an intermediate time step t somewhere between a fully noisy image and a noiseless image, for example, time step t=800. Then, at each time step t (e.g., time step t=800 in this case), an estimate of the image at time step 0 is generated, which is shown as image 606. In this example, it is desired to generate a first type of defect (NG-1) but instead, a different type of defect (NG-3) was generated at image 606. This may occur, for example, because the probability of the class corresponding to NG-3 is greater than the probability of the defect corresponding to NG-1 according to the pre-trained multi-class classifier. The following equation may be utilized to compute a guidance strength based on these probabilities:

$$ω = α exp ( - β ( p ( {c}_{out} ) - p ( {c}_{in} ) ) ) \qquad ( Equation 1 )$$

wherein ω is the guidance strength, cₒᵤₜ is the desired class (e.g., the desired class of defect), cᵢₙ is the reference class (e.g., the defect that is being confused with). Therefore, by plugging in these probabilities to Equation 1, the guidance strength w may be determined. In this example, because the probability of the desired class is lower than the reference class, the guidance strength w=2 (a relatively higher value). Then, this guidance strength may be plugged in to a denoising equation:

ε_{θ}(xₜ,t,c)˜ε_{θ}(c)

ε_{θ}=ε_{θ}(cₒᵤₜ)+ω(ε_{θ}(cₒᵤₜ)−ε_{θ}(cᵢₙ) (Equation 2)

wherein ε_{θ} is the amount of noise at time step t to determine the amount of noise ε_{θ} to denoise at the time step (e.g., time step t=800) to get to the next time step (e.g., time step t=799 in this case) to generate image 608. Accordingly, a defect image that is slightly more similar to the desired class may be generated.

This process may be repeated again at time step 799. When the image at time step 0 is estimated based off of noisy image 608, image 610 may be estimated. In this case, the probability for the class of defect corresponding to NG-1 is the highest probability and the probability for the class of defect corresponding to NG-3 is now a lower probability. Therefore, by plugging in these probabilities to Equation 1, a relatively lower guidance strength w=0.5 is computed because the defect image is now closer to the desired class. By plugging in the new guidance strength to Equation 2, a new amount of noise ε_{θ} to denoise may be determined and this amount of noise may be denoised to generate image 612. When this step is repeated until the image at time step 0 is generated, an enhanced synthetic defect image may be generated.

Some conventional models known in the art may use constant values for w, or determine w empirically. However, according to one or more embodiments of the present disclosure, w=α exp[−β(p1−p2)], with α>0 and β>0, and w=min (w, wₘₐₓ), where wₘₐₓ is a constant upper limit, and where p1 and p2 are probabilities from the classifier. p1 and p2 may be defined based on two possible cases. According to a first case, class x has the highest classifier probability, wherein p(x)>p(y)> and so on. Thus, the classifier may be considered as having a relatively high classifier confidence, and therefore needs a relatively low guidance strength w. As a result, p1=p(x) and p2 is the probability of second highest probability class, and therefore p1−p2 will be a positive value and w will be relatively low. According to a second case, class x does not have the highest classifier probability. For example, class y may have the highest probability, wherein p(y)>p(x)> . . . or p(y)>p(z)>p(x)> . . . . Thus, the classifier has a relatively lower classifier confidence, and therefore needs a higher guidance strength w. As a result, p1=p(x) and p2 is the probability of highest probability class, and therefore p1−p2 will be a negative value, and w will be a relatively higher value. When the classifier has a higher confidence that the defect generated is of class x, then a relatively lower guidance strength w is sufficient because there is a greater probability that the diffusion model is not making a mistake. On the other hand, if the classifier provides that class y has the highest ranked probability when we are trying to generate a class x, then a higher guidance strength w may be desired to guide the sampling step so that the diffusion model can generate class X.

In some embodiments, the classifier may rank probabilities of not just one defect class (e.g., comparing class x with class y) but further rank the probabilities of a plurality of different defect classes (e.g., comparing class x with both class y and class z) to generate a plurality of different guidance strengths, one for each defect class with respect to the reference class (e.g., class x). In such case, the following equation may be used: ε_{θ}=ε_{θ}(cₒᵤₜ)+ω1(ε_{θ}(cₒᵤₜ)−ε_{θ}(cᵢₙ₁)+ω2(ε_{θ}(cₒᵤₜ)−ε_{θ}(cᵢₙ₂)+ . . . wherein w1 corresponds to a first guidance strength, and w2 corresponds to a second guidance strength, and so on.

It should be noted that while in the above example, the guidance strength w was determined by an exponential function in Equation 1, but in one or more other embodiments, the guidance strength may be determined by a power law function, for example: w=η(|p1−p2|)θ, with η>0 and θ>0, where θ>1 when p1>p2 and θ<1 when p1<p2.

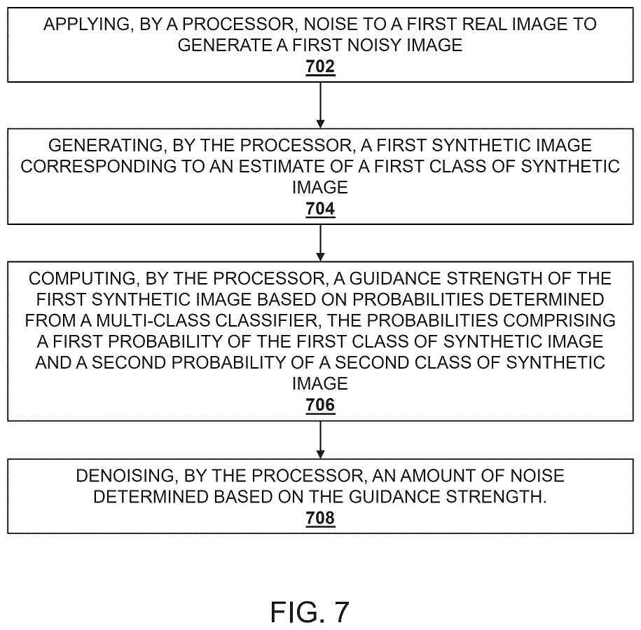

FIG. 7 is a flow chart of a method for synthetic defect image generation using diffusion models, according to one or more embodiments of the present disclosure.

The method may first assume that a multi-class classifier based on a source product is available or provided. Then, according to one or more embodiments of the present disclosure, a processor may apply noise to a first real image (e.g., of a target product) to generate a first noisy image (702). For example, the first noisy image may correspond to an image as time step t=800 or other time step such as time step t=700 or t=750, and the like, as shown in FIG. 5. Next, an estimate of a first synthetic image corresponding to a first class of synthetic image at time step t=0 may be generated (704). In other words, the processor estimates what the first synthetic image of a first class of synthetic image would look like if the noisy image was denoised. However, this estimated first synthetic image may not necessarily look like a first synthetic image of a first class, but instead it may look more like a synthetic image of another class (e.g., second class or third class). Therefore, the processor may compute a guidance strength of the first synthetic image based on probabilities determined from the multi-class classifier. The probabilities from the multi-class classifier may include a first probability of the first class of synthetic image and a second probability of a second class of synthetic image (706). Based on the computed guidance strength, the processor may compute the amount of noise that it should denoise from the noisy image so that a synthetic image that more closely resembles the first class of synthetic image may be generated (708). This process may be repeated until a fully noiseless image corresponding to a first class of synthetic image is generated.

Accordingly, the above-described techniques may be utilized to enrich the quality of defect images generated by the multi-class diffusion model so that an improved and more robust multi-class classifier may be trained and deployed in a factory, which may ultimately be used to detect, identify, remove, and/or fix defective components, portions of components, and/or products. More particularly, the factory may produce one or more electronic devices such as, for example, a display device, a smartphone, an OLED/QD-LED display, and the like, which may include corresponding circuitry (e.g., microchips with circuitry that are produced by semiconductor fabrication processes). During the production of such products, defects may be present in the circuitry that are so small that they may be indistinguishable by the naked human eye. For example, a short circuit or an open circuit may be present in the circuitry from the semiconductor fabrication process. Thus, inspection systems that use optics (e.g., cameras) and computers with AI/ML may be improved to detect, identify, remove, and/or repair such defects.

Furthermore, it should be noted that the embodiments of the present disclosure are not limited to the above-described examples, and that a person having ordinary skill in the art may implement these techniques in other applications where detection and identification are desired to ensure quality assurance of one or more products. Moreover, the diffusion model may be implemented not only to generate fake multi-class defect images from OK images but rather any image or physical attribute alteration from one class of images or physical attributes to another class of images or physical attributes that may be used for anomaly detection in time series data. For example, a manufacturing line that produces a machine such as a robot may include sensors that measure various physical attributes (e.g., torque, position, velocity, etc.) of the robot to ensure the attributes meet certain criteria or thresholds. As with the above-described electronic device example, an abundance of defect free data (e.g., OK physical attributes) for a normally functioning robot may be available but lack multi-class defect data for the robot (i.e., physical attributes that would cause the robot to fail or nearly fail). Thus, the diffusion model may be used to generate fake multi-class defect data for early detection of potential robot failure, and therefore actual robot failure may be prevented or corrected before actually failing. Accordingly, the diffusion model of the present disclosure may be implemented for use in various anomaly or defect detection scenarios.

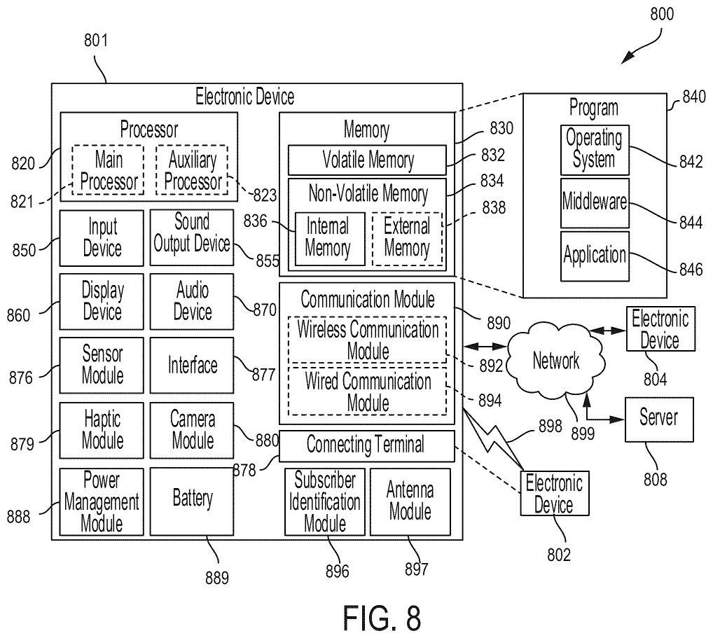

FIG. 8 is a block diagram of an electronic device in a network environment 800 that may be configured to include the AI-based classifier including a neural network, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims and their equivalents.

What is claimed is:

1. A method comprising:
applying, by a processor, noise to a first real image to generate a first noisy image;
generating, by the processor, a first synthetic image corresponding to an estimate of a first class of synthetic image;
computing, by the processor, a guidance strength of the first synthetic image based on probabilities determined from a multi-class classifier; and
denoising, by the processor, an amount of noise determined based on the guidance strength.

2. The method of claim 1, wherein the probabilities comprise a first probability of the first class of synthetic image and a second probability of a second class of synthetic image.

3. The method of claim 1, wherein the first real image is a defect free image of a target.

4. The method of claim 1, wherein the first class of synthetic image corresponds to a desired class of a defect image of a target.

5. The method of claim 2, wherein the guidance strength is computed using an exponential function of a difference between the first probability of the first class of synthetic image and the second probability of the second class of synthetic image.

6. The method of claim 5, wherein the second class of synthetic image corresponds to a reference class of image of a target, the reference class being another class of a defect image of the target.

7. The method of claim 6, wherein the guidance strength is relatively lower in response to the first probability of the first class of synthetic image being a highest probability out of all classes of the multi-class classifier.

8. The method of claim 6, wherein the guidance strength is relatively higher in response to the second probability of the second class of synthetic image being a highest probability out of all classes of the multi-class classifier.

9. The method of claim 1,
wherein the guidance strength is computed using a power law function, and
wherein the multi-class classifier is trained based on a source.

10. The method of claim 1, further comprising generating the first class of the synthetic image responsive to the denoising.

11. A system comprising:
a processor; and
a memory storing instructions executed by the processor to cause the processor to:
apply noise to a first real image to generate a first noisy image;
generate a first synthetic image corresponding to an estimate of a first class of synthetic image;
compute a guidance strength of the first synthetic image based on probabilities determined from a multi-class classifier; and
denoising, by the processor, an amount of noise determined based on the guidance strength.

12. The system of claim 11, wherein the probabilities comprise a first probability of the first class of synthetic image and a second probability of a second class of synthetic image.

13. The system of claim 11, wherein the first real image is a defect free image of a target.

14. The system of claim 11, wherein the first class of synthetic image corresponds to a desired class of a defect image of a target.

15. The system of claim 12, wherein the guidance strength is computed using an exponential function of a difference between the first probability of the first class of synthetic image and the second probability of the second class of synthetic image.

16. The system of claim 15, wherein the second class of synthetic image corresponds to a reference class of image of a target, the reference class being another class of a defect image of the target.

17. The system of claim 16, wherein the guidance strength is relatively lower in response to the first probability of the first class of synthetic image being a highest probability out of all classes of the multi-class classifier.

18. The system of claim 16, wherein the guidance strength is relatively higher in response to the second probability of the second class of synthetic image being a highest probability out of all classes of the multi-class classifier.

19. The system of claim 11,
wherein the guidance strength is computed using a power law function, and
wherein the multi-class classifier is trained based on a source.

20. The system of claim 11, wherein the processor further generates the first class of the synthetic image responsive to the denoising.
